(19) United States
(12) Patent Application Publication
(10) Pub. No.: US 2004/0253987 A1
(43) Pub. Date: Dec. 16, 2004

(54) Method and device for determining distributed signal sources of a base station

(75) Inventor: Jooshik Lee, Anyang (KR)

Correspondence Address: FLESHNER & KIM, LLP, P.O. BOX 221200, CHANTILLY, VA, 20153, US

(73) Assignee: LG Electronics Inc.

(21) Appl. No.: 10/852,605

(22) Filed: May 25, 2004

(30) Foreign Application Priority Data
May 26, 2003 (KR) 33479/2003

(51) Int. Cl. H04B 1/06

(52) U.S. Cl. 455/562.1; 455/269; 342/417

(57) ABSTRACT

A method and device are provided for determining distributed signal sources of a base station that includes a pair of circular array antennas that maintain a predetermined distance from each other. The method and device may estimate primary central vertical angles of the distributed signal sources received by each sensor according to TLS-ESPRIT, for example. The method and device may further convert a 2-dimensional cost function into a first 1-dimensional cost function by using the estimated primary central vertical angles of the distributed signal sources. Central horizontal angles may be estimated by making the first 1-dimensional cost function have a maximum. The 2-dimensional cost function may be converted into a second 1-dimensional cost function by using the estimated central horizontal angles of the distributed signal sources. The central vertical angles may be estimated by making the second 1-dimensional function have a maximum.

The present application claims priority from Korean Patent Application No. 33479/2003, filed May 26, 2003, the subject matter of which is incorporated herein by reference.

### BACKGROUND OF THE INVENTION

1. Field of the Invention

Embodiments of the present invention may relate to determining signal sources of a mobile communication base station. More particularly, embodiments of the present invention may relate to a method and device for determining distributed signal sources of a base station having adaptive antennas. 2. Background of Related Art

In a mobile communication system, radio signals may be transmitted through multiple paths and thus may become distributed signal sources. A base station may estimate signal arrival directions of the distributed signal sources (i.e., a direction of a mobile communication terminal) by using a circular array antenna 10 as shown in FIG. 1. In the circular array antenna 10, a plurality of sensors 20 may be arranged at predetermined intervals along a circumference of a radius R from an axis 30.

Each of the sensors 20 of the circular array antenna 10 may individually perform an antenna function. When each sensor 20 receives signals from one signal source, the received signals may have phase differences. The base station may estimate optimum signal arrival directions and form beams in the estimated direction by compensating for or correcting the phase differences of the received signals.

FIG. 2 is a diagram of a device for determining signal sources of a base station by using the circular array antenna 10 according to an example arrangement. Other arrangements are also possible.

The device for determining the signal sources of the base station may include a 2-D searching unit 40 for simultaneously estimating central vertical angles and central horizontal angles of distributed signal sources from the circular array antenna 10 by using a 2-D cost function (i.e., a 2-dimensional cost function). The device may also include a control unit 50 to form beams in signal arrival directions of the distributed signal sources by using the central vertical angles and the central horizontal angles estimated by the 2-D searching unit 40.

When estimating the signal arrival directions of the distributed signal sources by using one circular array antenna 10, the base station may use the 2-D cost function (or the 2-dimensional decision function) such as the following Formula 1 having the central vertical angles and the central horizontal angles as parameters:

$$V ( θ , φ ) = \frac{1}{1 - {\hat{λ}}_{max} ( θ , φ )} \qquad Formula 1$$

Here, \hat{λ}ₘₐₓ(θ,φ) is the maximum eigenvalue of the matrix \hat{T}(θ,φ)=Êₛ^{H} ψ(θ,φ)Êₛ*ψ(θ,φ)Êₛ, Êₛ is a signal eigenvector matrix, ψ(θ,φ) which is L×L is a diagonal matrix satisfying ψ(θ,φ)=diag(e^{j2η sin θ cos(φ-γ}^{₁}⁾, . . . , e^{j2η sin θ cos(φ-γ}^{_{L}}⁾), η is a constant number relating to the radius R of the circular array antenna and the distance between the sensors 10, γₖ is

$$\frac{2 π ( k - 1 )}{L} ,$$

and L is a number of the sensors 20.

The 2-D cost function has been described in Q. Wan and Y.-N. Peng, “Low-Complexity Estimator for Four-Dimensional Parameters Under a Reparameterized Distributed Source Model,” IEEE Proc.-Radar, Sonar, Navig., vol. 148, pp. 313-317, December 2001, the subject matter of which is incorporated herein by reference.

The distributed signal sources received by the sensors 20 of the circular array antenna 10 may be transmitted to the 2-D searching unit 40. The 2-D searching unit 40 may set an initial value according to Newton's method, and simultaneously estimate values such that the 2-D cost function has a maximum value as set forth in the following Formula 2 (i.e., optimum central vertical angles and central horizontal angles of the distributed signal sources on the basis of the set initial value):

$$( \hat{θ} , \hat{φ} ) = arg {max}_{θ , φ} V ( θ , φ ) \qquad Formula 2$$

When the estimated central vertical angles and central horizontal angles of the distributed signal sources are solutions making the 2-D cost function have a global maximum, not a local maximum, the control unit 50 may control formation of antenna beams in the directions of the estimated central vertical angles and central horizontal angles (i.e., namely in the signal arrival directions of the corresponding distributed signal sources).

Newton's method is a method to calculate a solution of a nonlinear multidimensional function. However, it may be difficult to always obtain the solution of the nonlinear multidimensional function. The initial value set according to Newton's method may be an approximate value of the solution (x of FIG. 3) making the 2-D cost function have a global maximum. However, it may be more likely that the initial value is an approximate value of the solution (x of FIG. 3) making the 2-D cost function have a local maximum.

Accordingly, a device to determine the distributed signal sources of the base station that calculates the 2-D cost function by using the distributed signal sources from one circular array antenna may set the initial value according to Newton's method, and obtain the solution making the 2-D cost function have the local maximum on the basis of the set initial value. Optimum signal arrival directions of the distributed signal sources may then not be obtained (or estimated).

In addition, a device to determine the distributed signal sources of the base station may simultaneously estimate the central vertical angles and the central horizontal angles when the nonlinear 2-D cost function has the maximum (or minimum), and also estimate the optimum central vertical angles and central horizontal angles, avoiding local maximum problems of the nonlinear 2-D function for the whole distributed signal sources, thereby requiring calculations to estimate the signal arrival directions of the distributed signal sources. As a result, the device to determine the distributed signal sources of the base station may generate loads on the beam formation system using one circular array antenna (or adaptive antenna).

### SUMMARY OF THE INVENTION

Embodiments of the present invention may provide a method and device for determining distributed signal sources of a base station that can reduce complexity of a method for estimating signal arrival directions of the distributed signal sources and prevent local maximum problems. This may be accomplished by estimating primary central vertical angles of the distributed signal sources by using a pair of circular array antennas. This may also be accomplished by estimating central horizontal angles of the distributed signal sources by applying the estimated primary central vertical angles to a 2-D cost function, and estimating central vertical angles of the distributed signal sources by applying the estimated central horizontal angles to the 2-D cost function.

A device may be provided for determining distributed signal sources of a base station that includes a pair of circular array antennas, a preprocessing unit, a central horizontal angle searching unit, and a central vertical angle searching unit. The pair of circular array antennas may be maintained a predetermined distance from each other (in the up/down direction). The preprocessing unit may estimate a primary central vertical angle of the distributed signal source from the pair of circular array antennas. The central horizontal angle searching unit may estimate a central horizontal angle of the distributed signal source by using the estimated primary central vertical angle. The central vertical angle searching unit may estimate a central vertical angle of the distributed signal source by using the estimated central horizontal angle.

A method may be provided for determining distributed signal sources of a base station. This may include receiving the distributed signal sources from each sensor on a pair of circular array antennas and estimating primary central vertical angles of the received distributed signal sources. This may also include estimating a central horizontal angle of one distributed signal source by using the primary central vertical angle of the distributed signal source and estimating a central vertical angle of the distributed signal source by using the estimated central horizontal angle.

The foregoing objects, features, aspects, advantages and/or embodiments of the present invention may become more apparent from the following detailed description when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate arrangements and embodiments of the invention and together with the description serve to further explain the principles of the invention.

The following represent brief descriptions of the drawing in which like reference numerals represent like elements and wherein:

FIG. 1 is a diagram of a circular array antenna of a base station according to an example arrangement;

FIG. 2 is a diagram of a device for determining signal sources of a base station by using a circular array antenna according to an example arrangement

FIG. 3 is a graph showing examples of a global maximum and a local maximum;

FIG. 4 is a diagram of a pair of circular array antennas in accordance with an example embodiment of the present invention;

FIG. 5 is a diagram of a device for determining distributed signal sources of a base station in accordance with an example embodiment of the present invention; and

FIG. 6 is a flowchart showing a method of determining distributed signal sources of a base station in accordance with an example embodiment of the present invention.

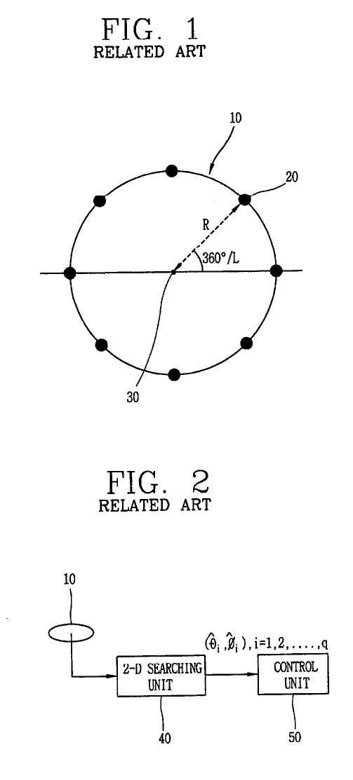

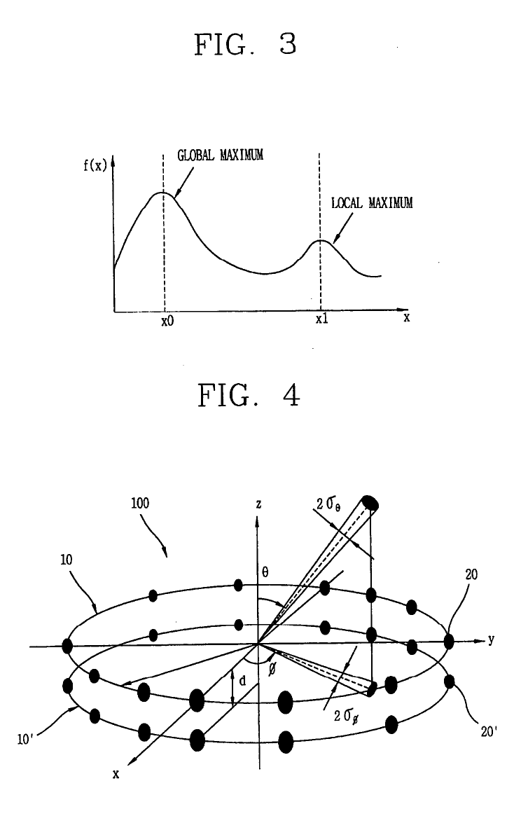

### DETAILED DESCRIPTION OF PREFERRED EMBODIMENTS

Embodiments of the present invention may employ a pair of circular array antennas as will be described below with respect to the accompanying drawings.

FIG. 4 is a diagram of a pair of circular array antennas in accordance with an example embodiment of the present invention. Other embodiments and configurations are also within the scope of the present invention. More specifically, FIG. 4 shows a pair of circular array antennas 100 such as a first circular array antenna 10 and a second circular array antenna 10′ disposed in upper and lower sides and having their axes on a similar line. The sensors 20 of the first circular array antenna 10 and the sensors 20′ of the second circular array antenna 10′ may be maintained a distance d apart from each other. The distance d may be a multiple of a wavelength λ, for example, λ/2 or λ.

Each of the distributed signal sources received by the pair of circular array antennas 100 may have a central vertical angle θ, a vertical angle distribution σ_{θ}, a central horizontal angle φ and a horizontal angle distribution σ_{φ}. Embodiments of the present invention may estimate signal arrival directions of the distributed signal sources and thus avoid estimating the vertical angle distribution σ_{θ} and the horizontal angle distribution σ_{φ}.

FIG. 5 is a diagram of a device for determining distributed signal sources of a base station in accordance with an example embodiment of the present invention. Other embodiments and configurations are also within the scope of the present invention.

As shown in FIG. 5, the device for determining the distributed signal sources of the base station may include a pair of circular array antennas 100 that maintain a predetermined distance between first and second circular array antennas 10 and 10′. The device may also include a preprocessing unit 110 to estimate primary central vertical angles of the distributed signal sources from the pair of circular array antennas 100. A central horizontal angle searching unit 120 may also be provided to generate a 1-D cost function by applying the estimated primary central vertical angles to a 2-D cost function, and to estimate central horizontal angles of the distributed signal sources by using the 1-D cost function. A central vertical angle searching unit 130 may generate a 1-D cost function by applying the estimated central horizontal angles to the 2-D cost function and estimate central vertical angles of the distributed signal sources by using the 1-D cost function. A control unit 140 may form a beam in a signal arrival direction of each distributed signal source by using the estimated central vertical angles and central horizontal angles.

When estimating the primary central vertical angles of the distributed signal sources, the preprocessing unit 110 may employ a MUSIC method, a maximum likelihood (ML) method, or a total least square-estimation of signal parameters via rotational invariance techniques (TLS-ESPRIT), for example. Other methods or methodologies are also within the scope of the present invention. The MUSIC method may estimate signal arrival directions satisfying orthogonality in a spectral-based point by using orthogonality between noise-related eigenvectors obtained by intrinsically separating a covariance matrix and control vectors for the real signal arrival directions. The ML method may find out variables for minimizing differences between a covariance matrix estimated by a parametric model and a theoretical covariance matrix including unknown variables. The TLS-ESPRIT may estimate signal arrival directions by using the structural characteristics of an antenna in a dot signal source model. TLS-ESPRIT has been described in R. Roy and T. Kailath, “ESPRIT-Estimation of Signal Parameters Via Rotational Invariance Techniques”, IEEE Trans. Acoust., Speech, Signal Process., vol. 37, pp. 984-995, July 1989, the subject matter of which is incorporated herein by reference.

The distributed signal sources may be received by the pair of circular array antennas 100 that maintain the predetermined distance from each other. Therefore, the TLS-ESPRIT used in the preprocessing unit 110 may obtain some relation between the control vectors of the pair of circular array antennas 100, display some relation as a matrix, and primarily estimate central vertical angles of the distributed signal sources from the relation between the eigenvectors of the matrix and the covariance matrix.

The ML method may more precisely estimate the signal arrival directions. However, because the ML method may estimate the signal arrival directions by using a nonlinear multidirectional function, the ML method may be very complicated, and require a good deal of time to process the corresponding signals. Accordingly, embodiments of the present invention may use the TLS-ESPRIT to estimate the primary central vertical angles of the distributed signal sources.

Operation of the device for determining the distributed signal sources of the base station in accordance with an example embodiment of the present invention will now be described.

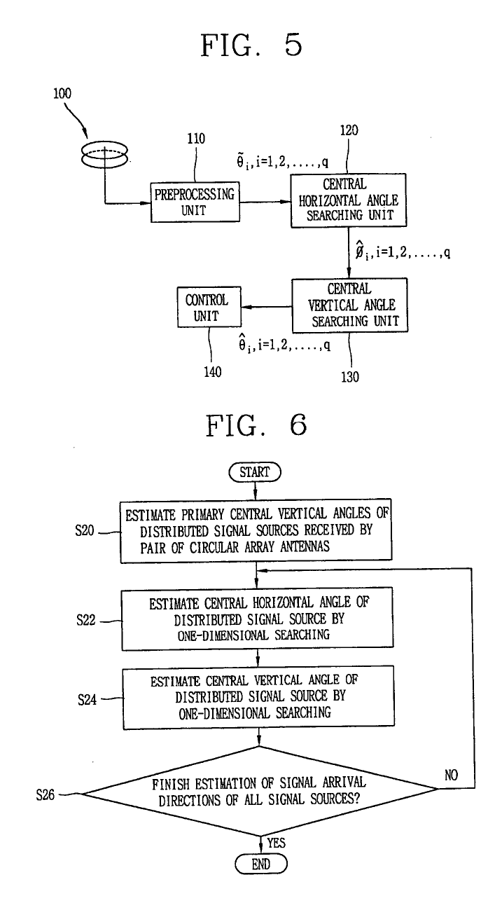

FIG. 6 is a flowchart showing a method of determining distributed signal sources of a base station in accordance with an example embodiment of the present invention. Other embodiments, operations and orders of operation are also within the scope of the present invention.

When the pair of circular array antennas 100 maintaining the predetermined distance d from each other (in the up/down direction) receive distributed signals, the preprocessing unit 110 may estimate the primary central vertical angles \tilde{θ} of the distributed signals received by each sensor 20 and 20′ (of the pair of circular array antennas 100) according to TLS-ESPRIT by using incident angles and phase differences of the distributed signals. The primary central vertical angles \tilde{θ} may not provide solutions making the 2-D cost function have a global maximum, but may provide approximate values of the solutions. The preprocessing unit 110 may estimate the primary central vertical angles \tilde{θ} of the whole distributed signal sources received by the pair of circular array antennas 100 (e.g., q distributed signals when a number of the distributed signal sources is q) (S20).

The central horizontal angle searching unit 120 may receive and input the primary central vertical angle \tilde{θ}ᵢ for solving 2-dimensional optimization problems as shown in formula 2 as central vertical angle variable θᵢ, and thus convert the 2-D cost function into a 1-D cost function for determining the central horizontal angle variable φᵢ, as shown by the following formula 3:

$${\hat{φ}}_{i} = arg {max}_{φ} V ( {\tilde{θ}}_{i} , {φ}_{i} ) \qquad Formula 3$$

Here, θᵢ denotes the central vertical angle variable of the i-th distributed signal source, and φᵢ denotes the central horizontal angle variable of the i-th distributed signal source.

The central horizontal angle searching unit 120 may estimate the solution using the 1-D function having the global maximum (i.e., the central horizontal angle \hat{φ}ᵢ of the i-th distributed signal source) (S22). The method for obtaining the solution of the 1-D function may be much easier in calculation than the method for obtaining the solution of the nonlinear 2-D function, and therefore may not obtain the solution having the local maximum.

The central vertical angle searching unit 130 may receive and input the estimated central horizontal angle \hat{φ}ᵢ of the i-th distributed signal source to the formula for solving 2-D optimization problems as shown in formula 2 as the central horizontal angle variable φᵢ, and thus convert the 2-D cost function into a 1-D function for determining the central vertical angle variable θᵢ, as represented by following formula 4:

$${\hat{θ}}_{i} = arg {max}_{θ} V ( {θ}_{i} , {\hat{φ}}_{i} ) \qquad Formula 4$$

Thereafter, the central vertical angle searching unit 130 may estimate the solution making the 1-D function have the global maximum (i.e., the central horizontal angle \hat{θ}ᵢ, of the i-th distributed signal source) (S24).

The central horizontal angle searching unit 120 and the central vertical angle searching unit 130 may confirm whether the central vertical angles and the central horizontal angles for q distributed signal sources have all been estimated. The central horizontal angle searching unit 120 and the central vertical angle searching unit 130 may sequentially perform estimation of the central horizontal angle using the primary central vertical angle, and perform estimation of the central vertical angle using the estimated central horizontal angle until the central vertical angles and the central horizontal angles for q distributed signal sources have all been estimated (S26).

When the central vertical angles and the central horizontal angles for q distributed signal sources have all been estimated, the control unit 140 may control beam formation in the signal arrival direction of each distributed signal source.

Embodiments of the present invention may include a method and device for determining (or searching for) the distributed signal sources of the base station so as to simplify primary estimation calculation and prevent local maximum problems by primarily estimating the central vertical angles of the distributed signal sources received by the pair of circular array antennas according to TLS-ESPRIT.

In addition, the method and device for determining the distributed signal sources of the base station may perform 1-D searching (i.e., 1-dimensional searching) by 2q times when q distributed signal sources exist by estimating the primary central vertical angles of the distributed signal sources, and sequentially performing estimation of the central horizontal angles of the distributed signal sources using the primary central vertical angles and estimating the central vertical angles of the distributed signal sources using the estimated central horizontal angles on each distributed signal source.

Furthermore, the method and device for determining the distributed signal sources of the base station may estimate the primary central vertical angles of the distributed signal sources, convert the 2-D cost function into the 1-D cost function for the central horizontal angle variables by inputting the primary central vertical angles of the distributed signal sources to the 2-D cost function, calculate the solutions making the 1-D cost function have the maximum (i.e., the central horizontal angles), convert the 2-D cost function into the 1-D cost function for the central vertical angle variables by inputting the calculated central horizontal angles to the 2-D cost function, and calculate the solutions making the 1-D cost function have the maximum (i.e., the central vertical angles). Calculation of the 1-D function may be easier than calculation of the nonlinear 2-D function. As a result, complexity of calculation for estimating the signal arrival directions of the distributed signal sources may be reduced, and loads on the base station may be reduced for estimating the signal arrival directions of the distributed signal sources.

Embodiments of the present invention may be embodied in several forms without departing from the spirit or essential characteristics thereof. It should also be understood that the above-described embodiments are not limited by any of the details of the foregoing description, unless otherwise specified, but rather should be construed broadly. Therefore, all changes and modifications that fall within the metes and bounds of the claims, or equivalence of such metes and bounds are therefore intended to be embraced by the appended claims.

What is claimed is:

1. A device to determine distributed signal sources, comprising:
a pair of array antennas;
a preprocessing unit to estimate a primary central vertical angle of the distributed signal source from the pair of circular array antennas;
a central horizontal angle searching unit to estimate a central horizontal angle of the distributed signal source based on the estimated primary central vertical angle; and
a central vertical angle searching unit to estimate a central vertical angle of the distributed signal source based on the estimated central horizontal angle.

2. The device of claim 1, wherein two axes of the pair of array antennas are disposed on a same line and the array antennas are maintained a predetermined distance apart from each other, and the pair of array antennas include sensors.

3. The device of claim 2, wherein the predetermined distance comprises a multiple of a wavelength.

4. The device of claim 1, wherein the preprocessing unit estimates the primary central vertical angle of the distributed signal source received by the pair of array antennas based on TLS-ESPRIT.

5. The device of claim 1, wherein the central horizontal angle searching unit generates a first 1-dimensional cost function for a central horizontal angle variable by using the primary central vertical angle as a value of a central vertical angle variable in a 2-dimensional cost function for the central vertical angle variable and the central horizontal angle variable, and the central horizontal angle searching unit estimates the central horizontal angle of the distributed signal source based on the first 1-dimensional cost function having a maximum value.

6. The device of claim 1, wherein the central vertical angle searching unit generates a second 1-dimensional cost function for a central vertical angle variable by using the estimated central horizontal angle as a value of a central horizontal angle variable in a 2-dimensional cost function for the central vertical angle variable and the central horizontal angle variable, and the central horizontal angle searching unit estimates the central vertical angle of the distributed signal source based on the second 1-dimensional cost function having a maximum value.

7. The device of claim 1, further comprising a control unit to form a beam in a signal arrival direction of the distributed signal source by using the estimated central vertical angle and the estimated central horizontal angle.

8. The device of claim 1, wherein the pair of array antennas comprises a pair of circular array antennas.

9. A method of determining distributed signal sources, comprising:
receiving the distributed signal sources;
estimating primary central vertical angles of the received distributed signal sources;
estimating a central horizontal angle of one distributed signal source based on the estimated primary central vertical angle; and
estimating a central vertical angle of the distributed signal source based on the estimated central horizontal angle.

10. The method of claim 9, further comprising sequentially performing the estimating the central horizontal angle and the estimating the central vertical angle for each of the distributed signal sources.

11. The method of claim 9, wherein the distributed signal sources are received by sensors on a pair of circular array antennas.

12. The method of claim 11, wherein two axes of the pair of circular array antennas are disposed on a same line and each of the antennas are spaced a predetermined distance apart from each other.

13. The method of claim 12, wherein the predetermined distance comprises a multiple of a wavelength.

14. The method of claim 11, wherein estimating the primary central vertical angles comprises estimates the primary central vertical angles of the distributed signal sources received by each sensor of the pair of circular array antennas according to TLS-ESPRIT.

15. The method of claim 9, wherein estimating the central horizontal angle of the distributed signal source comprises:
converting a 2-dimensional cost function for central vertical angle variables and central horizontal angle variables into a first 1-dimensional cost function for the central horizontal angle variables; and
estimating the central horizontal angle of the distributed signal source making the first 1-dimensional cost function have a maximum value.

16. The method of claim 15, wherein converting the 2-dimensional cost function to the first 1-dimensional cost function involves using the primary central vertical angle to the 2-dimensional cost function for the central vertical angle variables and central horizontal angle variables as a value of the central vertical angle variable.

17. The method of claim 15, wherein estimating the central vertical angle of the distributed signal source comprises:
converting a 2-dimensional cost function for central vertical angle variables and central horizontal angle variables into a second 1-dimensional cost function for the central vertical angle variables; and
estimating the central vertical angle of the distributed signal source based on the second 1-dimensional cost function having a maximum value.

18. The method of claim 17, wherein converting the 2-dimensional cost function into the second 1-dimensional cost function involves using the estimated central horizontal angle in the 2-dimensional cost function for the central vertical angle variables and central horizontal angle variables as a value of the central horizontal angle variables.

19. An apparatus comprising:
a plurality of array antennas having a plurality of sensors;
an estimating device to estimate a central vertical angle of a signal received by the plurality of sensors; and
a control device to form a beam in a direction based on the estimated central vertical angle.

20. The apparatus of claim 19, wherein the estimating device comprises:
a preprocessing unit to estimate a primary central vertical angle of the signal from the pair of array antennas;
a central horizontal angle searching unit to estimate a central horizontal angle of the signal based on the estimated primary central vertical angle; and
a central vertical angle searching unit to estimate a central vertical angle of the signal based on the estimated central horizontal angle.

21. The device of claim 20, wherein the preprocessing unit estimates the primary central vertical angle of the distributed signal source received by the pair of array antennas based on TLS-ESPRIT.

22. The device of claim 19, wherein two axes of the pair of array antennas are disposed on a same line and the array antennas are maintained a predetermined distance apart from each other, and the pair of array antennas include sensors.

23. The device of claim 22, wherein the predetermined distance comprises a multiple of a wavelength.

24. The device of claim 19, wherein the pair of array antennas comprises a pair of circular array antennas.

25. The device of claim 19, wherein the device comprises a base station.

26. A method comprising:
receiving a signal at a plurality of locations;
estimating a central vertical angle of the signal received at the plurality of locations; and
forming a beam in a direction based on the estimated central vertical angle.

27. The method of claim 26, wherein estimating the central vertical angle comprises:
estimating primary central vertical angles of the received signals;
estimating a central horizontal angle of one distributed signal source based on the estimated primary central vertical angle; and
estimating the central vertical angle of the distributed signal source based on the estimated central horizontal angle.

28. The method of claim 27, further comprising sequentially performing the estimating the central horizontal angle and the estimating the central vertical angle for each of a plurality of distributed signal sources.

29. The method of claim 27, wherein estimating the primary central vertical angles comprises estimates the primary central vertical angles of the signals received by each sensor of a pair of array antennas according to TLS-ESPRIT.

30. The method of claim 27, wherein estimating the central horizontal angle of the signal comprises:
converting a 2-dimensional cost function for central vertical angle variables and central horizontal angle variables into a first 1-dimensional cost function for the central horizontal angle variables; and
estimating the central horizontal angle of the signal making the first 1-dimensional cost function have a maximum value.

31. The method of claim 30, wherein converting the 2-dimensional cost function to the first 1-dimensional cost function involves using the primary central vertical angle to the 2-dimensional cost function for the central vertical angle variables and central horizontal angle variables as a value of the central vertical angle variable.

32. The method of claim 31, wherein estimating the central vertical angle of the signal comprises:
converting a 2-dimensional cost function for central vertical angle variables and central horizontal angle variables into a second 1-dimensional cost function for the central vertical angle variables; and
estimating the central vertical angle of the distributed signal source based on the second 1-dimensional cost function having a maximum value.

33. The method of claim 32, wherein converting the 2-dimensional cost function into the second 1-dimensional cost function involves using the estimated central horizontal angle in the 2-dimensional cost function for the central vertical angle variables and central horizontal angle variables as a value of the central horizontal angle variables.
